(19) United States
(12) Patent Application Publication
(10) Pub. No.: US 2023/0070473 A1
(43) Pub. Date: Mar. 9, 2023

(54) APPLICATOR ROLL, TIRE COMPONENT SERVICER AND METHOD FOR APPLYING A STRIP TO A DRUM

(71) Applicant: VMI HOLLAND B.V., Epe (NL)

(72) Inventors: Antonie SLOTS, Epe (NL); Henrick Theodoor POSTHUMUS, Epe (NL)

(21) Appl. No.: 17/800,985

(22) PCT Filed: Feb. 15, 2021
(86) PCT No.: PCT/NL2021/050097

§ 371 Date: Aug. 19, 2022

(30) Foreign Application Priority Data
Feb. 20, 2020 (NL) 2024951

(51) Int. Cl. B65H 27/00; B29C 48/30; B29D 30/00; B29D 30/28; B29D 30/30; B29D 30/62

(52) U.S. Cl. CPC B65H 27/00; B29C 48/30; B29D 30/0016; B29D 30/0061; B29D 30/28; B29D 30/30; B29D 30/62; B29D 2030/0038; B29D 2030/241

(57) ABSTRACT

An applicator roll, a tire component servicer, and a method for applying a strip to a drum are provided. The applicator roll includes an outer ring that is rotatable about a rotation axis and that defines a retaining surface. The applicator roll is provided with suction openings for retaining the strip to the retaining surface. The applicator roll includes a follower that is rotatable inside the outer ring to follow a part of the strip on the retaining surface. The follower defines a chamber that extends in the circumferential direction over a retaining arc along the outer ring. The follower is rotatable about the rotation axis independently of the outer ring to a first retaining position on the outer ring in which the chamber is arranged in air communication with one or more suction openings within said retaining arc.

### BACKGROUND

The invention relates to an applicator roll, a tire component servicer and a method for applying a strip to a drum.

DE 27 40 609 A1 discloses an applicator, acting as an intermediate carrier for the applied layers, with suction cups on the periphery connectable to a vacuum source. The applicator has an outer shell that encloses an annular chamber that is circumferentially sealed by two partition walls alternately mounted to the drum body and the outer shell. The annular chamber is connected to a vacuum source. As the leading end of a layer is moved onto the applicator, the drum body is held stationary while the outer shell rotates, thus moving the two partition walls progressively apart at the same rate at which the layer is fed around the outer shell. Hence, the suction cups of the applicator are connected to the vacuum source solely along the progressively increasing circumferential area of the outer shell as defined by the partition walls. In this way, pressure loss in the uncovered areas of the applicator can be prevented.

The applicator retains the entire length of the applied layers prior to the transfer thereof to a building drum. The applicator is then rotated in the opposite direction to transfer the applied layers from the applicator onto the building drum, thereby progressively decreasing the circumferential area that is connected to the vacuum source in accordance with the applied layers being transferred. The applicator thus facilitates the intermediate storage and subsequent transfer of the applied layers, and therefore acts as a so-called transfer wheel or a transfer drum.

WO 2012/072932 A1 discloses a transfer device for receiving and temporarily supporting a tire component before transferring said tire component to a manufacturing drum. The transfer device comprises a cylindrical support member with a plurality of suction cups distributed around its circumference. The suction cups are connected to a central ring that rotates together with the cylindrical support member and that defines a housing. The transfer device further comprises a plug that is stationary within the housing and that divides the housing into an outer chamber that is connected to a vacuum source and an inner chamber that is supplied with compressed air. As the cylindrical support member is rotated relative to the plug inside the housing, the suction cups are connected to the outer chamber for most of the rotation and are only briefly connected to the inner chamber, at which point in time the connection with the vacuum is briefly interrupted and replaced with compressed air to separate the tire component retained to the respective suction cups.

### SUMMARY OF THE INVENTION

A disadvantage of the known applicator according to DE 27 40 609 A1 is that it only allows for progressively retaining the applied layers as a whole from the leading end up to the trailing end before progressively releasing the applied layers as a whole in reverse order from the trailing end up to the leading end. In other words, the known applicator does not allow for releasing and transferring the leading end of the applied layers to the building drum before the trailing end of the same applied layers has arrived at the applicator and/or for independently retaining and releasing the leading end and the trailing end of the same applied layers. Hence, the rotation dependent increase and decrease of the circumferential area does not work for a continuous application process, i.e. an application process in which the applicator continuously rotates in the same direction to apply the strip directly to the building drum instead of storing the applied layers on the applicator.

A disadvantage of the transfer device according to WO 2012/072932 A1 is that the active circumferential area cannot be limited to where suction is actually needed to retain the tire component. Hence, in a continuous application process where only a part of the tire component is retained along a limited circumferential area of the transfer device, the uncovered areas of the transfer device will cause a considerable pressure loss. Moreover, the angular positions of the chambers of the housing are not adjustable to adapt for different process conditions, i.e. variations in angular pick-up and/or second retaining positions of (parts of) the tire component.

It is an object of the present invention to provide an applicator roll, a tire component servicer and a method for applying a strip to a drum, wherein the applicator roll can be used in continuous application process and/or wherein the flexibility of the continuous application process can be improved.

According to a first aspect, the invention provides an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the applicator roll further comprises a follower that is rotatable inside the outer ring about the rotation axis to follow a part of the strip on the retaining surface, wherein the follower defines a chamber that extends in the circumferential direction over a retaining arc along the outer ring and that is connectable to a vacuum source, wherein the follower is rotatable about the rotation axis independently of the outer ring to a first retaining position on the outer ring in which the chamber is arranged in air communication with one or more suction openings of the plurality of suction openings within said retaining arc.

Preferably, the follower is arranged for rotation together with the outer ring about the rotation axis while remaining in the first retaining position on the outer ring. The follower can thus retain the part of the strip to the outer ring in the first retaining position and then follow the retained part of the strip as it is being conveyed by the rotation of the outer ring towards the drum.

More preferably, the follower comprises a first fixation element for fixating the follower in the first retaining position on the outer ring. By fixating the follower with respect to the outer ring, it can be ensured that the follower rotates in the same direction and with the same speed as the outer ring. Moreover, the follower does not require its own rotational drive means, as it can simply tag along with the outer ring.

The follower can be positioned independently of the outer ring. The follower can for example rotate in the same direction as the outer ring, in an opposite direction or at a different rotation speed relative to the outer ring. Hence, the chamber defined by said follower can be positioned freely and/or independently to provide suction or compressed air at a specific position along the outer ring. Hence, the applicator roll can be easily adapted to certain process conditions, i.e. to retain a part of the strip to the retaining surface at a customizable first retaining position on said outer ring, to release said part of the strip in a customizable second retaining position on the outer ring and/or to retain said part of the strip only during a limited time or only during a limited rotation of the outer ring, i.e. less than a full revolution. The arc length of the retaining arc may be limited to the length of the retaining surface over which the part of the strip is retained. Hence, pressure loss or loss of vacuum can be prevented.

Consequently, the follower according to the invention can provide increased flexibility when retaining a part of the strip to the applicator roll, in particular during a continuous application process in which the outer ring continuously rotates in the same direction to apply the strip directly to the building drum.

Preferably, the follower is rotatable about the rotation axis independently of the outer ring in a first rotation direction and a second rotation direction opposite to the first rotation direction. Hence, the follower can be returned to its initial position without having to rotate further with the outer ring. This is particularly useful in case of a continuous application process in which the outer ring is continuously rotated in the same direction. The follower can thus be repositioned quickly and independently of the outer ring.

In a further embodiment the follower is freely rotatable about the rotation axis independently of the outer ring when the first fixation element has terminated the fixation of the follower on the outer ring. Hence, the follower can be repositioned with respect to the outer ring once the fixation has been terminated.

In a further embodiment the first fixation element is movable between a first fixation position in abutment with the outer ring and a first retracted position spaced apart from the outer ring, wherein the fixation of the follower to the outer ring is obtained by friction between the first fixation element and the outer ring in the first fixation position. By physically abutting the outer ring, a relatively easy frictional fixation between the follower and the outer ring can be obtained.

Preferably, the follower comprises a second fixation element that is arranged for abutting the outer ring in a second fixation position. Hence, the follower can be fixated relative to the outer ring more securely. Moreover, the second fixation element can at least cancel out the force exerted onto the outer ring by the first fixation element.

In a particular embodiment thereof, the second fixation position is diametrically opposite to the first fixation position. The follower can thus be fixated in two diametrically opposite directions, i.e. by spreading the respective fixation elements apart and into abutting contact with the outer ring. The force exerted by the first fixation element onto the outer ring can be cancelled out by the force exerted by the second fixation element on the outer ring.

In a further embodiment the chamber is formed in the first fixation element. Hence, the chamber can be moved towards and away from the outer ring in accordance with the movement of the first fixation element between the first fixation position and the first retracted position.

In an embodiment thereof, in the first fixation position, the first fixation element seals the chamber from communication with any one of the suction openings of the plurality of suction openings outside of the retaining arc and wherein, in the first retracted position, the chamber is in open communication with the suction openings of the plurality of suction openings outside of the retaining arc. Hence, the chamber is automatically sealed to communicate only with the suction openings within the retaining arc upon fixation of the follower to the outer ring.

In a further embodiment the first fixation element comprises a cylinder and a piston movable in said cylinder between the first fixation position and the first retracted position, wherein the piston comprises a braking surface for contacting the outer ring in the first fixation position. The piston may be moved within the cylinder by a drive fluid, i.e. pneumatically or hydraulically.

In a further embodiment the follower comprises a follower body for supporting the first fixation element with respect the rotation axis. The follower body may for example be arranged to be placed on a shaft to which the applicator roll is fitted.

In another embodiment the follower comprises a follower body that has the shape of an inner disc that fits concentrically inside the outer ring. The inner disc can thus support the outer ring and may serve as a guide for guiding the rotation of the outer ring with respect to the follower.

In another embodiment the follower has an angular start position and an angular end position that is offset with respect to the angular start position about the rotation axis, wherein the follower is arranged for rotating together with the outer ring from the angular start position to the angular end position. Hence, at least between the angular start position and the angular end position, the follower can be rotated at the same speed and in the same direction as the outer ring. The part of the strip may thus be retained in the first retaining position on the outer ring at least during the rotation of said outer ring from the angular start position to the angular end position.

In an embodiment thereof the angular end position is offset from the angular start position over at least thirty degrees about the rotation axis, preferably at least sixty degrees. The part of the strip may thus be retained in the first retaining position on the outer ring at least during the minimum angular displacement of the outer ring as specified.

In a further embodiment thereof the angular end position is offset from the angular start position over less than one-hundred-and-eighty degrees, preferably less than one-hundred-and-twenty. The part of the strip may thus be retained in the first retaining position on the outer ring only during the maximum angular displacement of the outer ring as specified.

In a further embodiment thereof, the follower is arranged for returning to the angular start position independently of the outer ring after rotating together with the outer ring from the angular start position to the angular end position. The follower may be rotated further in the same direction as the outer ring at the same speed or a different speed, or the follower may be returned in an opposite rotation direction. If the offset between the angular start position and the angular end position is less than one-hundred-and-eighty degrees, it can be quicker to return the follower in the opposite rotation direction.

Preferably, the follower is arranged for rotating from the angular start position to the angular end position in a first rotation direction, wherein the applicator roll comprises a biasing member for biasing the follower in a second rotation direction opposite to the first rotation direction to return to the angular start position. Hence, once co-rotation between the follower and the outer ring has been terminated, the follower will automatically be urged by the biasing member to return to the angular start position. For example, in the embodiment of the first fixation element, the release of the fixation between the follower and the outer ring will cause the follower to return to the angular start position. This has the advantage that—other than the passive biasing member—no active rotational drive means are required to return the follower to the angular start position.

More preferably, the applicator roll comprises a stopper element for preventing rotation of the follower in the second rotation direction beyond the angular start position. The stopper element may for example be strategically located to physically abut and/or block the rotation of the biasing member and/or the follower when said follower is in the angular start position.

In a further embodiment the follower has a zero position in which the chamber is pointing vertically upwards, wherein the angular start position is offset with respect to the zero position over three to twenty degrees. This angular start position may be convenient for reliably and/or securely picking up the initial part of the strip, i.e. the leading end, directly from an extruder. In particular, the follower may be tilted slightly towards the extruder die to communicate with one or more suction openings as close as possible to said extruder die to retain the leading end as close as possible to said extruder die.

In another embodiment the outer ring is rotatable about the rotation axis independently of the follower over one or more revolutions, wherein the follower is rotatable about the rotation axis to a second retaining position on the outer ring that is offset with respect to the first retaining position on the outer ring over at least one revolution of the outer ring about the rotation axis with respect to the follower. The first retaining position may correspond to the position where the leading end of the strip is first supported on or applied to the outer ring. Hence, the follower can follow the leading end of the strip when tagging along with the outer ring in said first retaining position. The leading end is then released, and the outer ring is rotated further over several revolutions to convey the main body of the strip towards the drum. The strip is ultimately cut off at or near the extruder, thereby creating a trailing end. The second retaining position may correspond to the position where said trailing end of the strip is first supported on or applied to the outer ring. Hence, the follower can follow said trailing end of the strip when tagging along with the outer ring in said second retaining position. The second retaining position may at least partially overlap with the first retaining position on the outer ring if it is offset by one or more full revolutions of the outer ring about the rotation axis.

In another embodiment the retaining arc has an arc length that is less than one-hundred-and-eighty degrees, preferably less than ninety degrees and more preferably less than forty-five degrees. The length of the chamber along the circumference of the outer ring can thus be limited to an area that is actually covered by the strip during the application process. This is particularly useful in a continuous application process in which the strip is supported only along a very small portion of the circumference of the outer ring. Hence, by preventing air communication between the chamber and suction openings that are not covered by the strip during the process, pressure loss or loss of vacuum through said uncovered suction openings can be prevented.

In another embodiment the retaining arc has an arc length that is chosen such that five suction openings of the plurality of suction openings or less are in air communication with the chamber at a time, preferably three suction openings of the plurality of suction openings or less and more preferably two suction openings of the plurality of suction openings or less. Hence, the number of suction openings that are ‘activated’ by the chamber, i.e. in air communication with said chamber, is very limited compared to the total number of suction openings. The part of the strip, i.e. the leading end or the trailing end thereof, can be retained very precisely.

According to a second aspect, the invention provides a tire component servicer comprising the applicator roll according to the first aspect of the invention.

The tire component servicer may include the applicator roll with all or a selection of the features as described in the previously discussed embodiments. Hence, the tire component servicer has the same or similar technical advantages.

Preferably, the tire component servicer comprises a first control element that is coupled to the outer ring for driving the rotation of said outer ring. The first control element can thus actively control and/or drive the rotation of the outer ring.

In one particular embodiment the follower comprises a first fixation element for fixating the follower in the first retaining position on the outer ring, wherein the tire component servicer comprises a second control element for controlling the first fixation element. As mentioned earlier, the first fixation element allows the follower to tag along with the outer ring without requiring its own active rotational drive means.

According to a third, unclaimed aspect the invention provides a tire component servicer comprising an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the applicator roll further comprises a follower that is rotatable inside the outer ring about the rotation axis to follow a part of the strip on the retaining surface, wherein the follower defines a chamber that extends in the circumferential direction over a retaining arc along the outer ring and that is connectable to a vacuum source, wherein the follower is rotatable about the rotation axis independently of the outer ring to a first retaining position on the outer ring in which the chamber is arranged in air communication with one or more suction openings of the plurality of suction openings within said retaining arc, wherein the tire component servicer comprises a first control element that is coupled to the outer ring for driving the rotation of said outer ring, wherein the tire component servicer comprises a second control element that is coupled to the follower for driving the rotation of the follower. In this embodiment, the follower and the outer ring are driven individually by separate control elements, i.e. two rotational drives. This has the advantage that the angular position of the follower can be actively controlled independently of the outer ring. During the rotation of the follower together with the outer ring, the two control elements may be synchronized to rotate the follower and the outer ring in unison. Alternatively, small and/or variable speed differences may be introduced if required.

In a further embodiment the tire component servicer further comprises a control unit that is operationally connected to the first control element and the second control element, wherein the control unit is configured to control the first control element and the second control element such that the follower is rotated together with the outer ring about the rotation axis while remaining in the first retaining position on the outer ring. The control unit may for example control the first fixation element or control both previously described control elements to rotate synchronously.

Preferably, the tire component servicer further comprises a sensor for detecting the presence of the strip on the applicator roll, wherein the control unit is operationally connected to the sensor and configured for controlling the first control element and/or the second control element in response to signals received from the sensor. The sensor can ensure that the process is initiated only when the presence of the strip, i.e. the leading end, is detected in the first retaining position on the outer ring.

In another embodiment the tire component servicer comprises a vacuum source, wherein the chamber is connectable to said vacuum source. Preferably, the tire component servicer further comprises a pump unit that is arranged for selectively providing a partial vacuum or compressed air to the chamber. The vacuum source and the pressure source may be the same source, i.e. a pump that can be reversed. Alternatively, two pumps may be used with a valve block in between for selectively switching between the sources. The same chamber can thus be used for retaining the part of the strip or releasing the part of the strip, i.e. by providing a burst of compressed air through the suction openings and thereby blowing off the part of the strip from the outer ring.

In another embodiment the tire component servicer further comprises an extruder with an extruder die for extruding the strip in an extrusion direction, wherein the applicator roll is located directly downstream of the extruder die in the extruder direction. The applicator roll can thus be used to pick-up and retain the strip as soon as it leaves the extruder.

Preferably, the rotation axis of the applicator roll is in a fixed position with respect to the extruder die. Hence, the applicator roll is arranged for applying the strip directly to a drum. This is different from transfer wheels that first collect the entire length of the strip, then move away from the servicer towards a building drum and transfer the entire strip, independently of the servicer, to the building drum.

In a further embodiment of the tire component servicer, the follower has an angular start position and an angular end position that is offset with respect to the angular start position about the rotation axis, wherein the follower is arranged for rotating together with the outer ring from the angular start position to the angular end position, wherein the follower is arranged for returning to the angular start position independently of the outer ring after rotating together with the outer ring from the angular start position to the angular end position, wherein the tire component servicer comprises a controllable actuator, wherein the controllable actuator is arranged for engaging directly onto a portion of the follower for actively returning the follower from the angular end position to the angular start position independently of the outer ring after rotating together with the outer ring from the angular start position to the angular end position. Hence, by controlling the return of the follower, the speed and/or positioning of the follower relative to said angular end position can be controlled more accurately.

According to a fourth aspect, the invention provides a method for applying a strip to a drum using the applicator roll according to the first aspect of the invention, wherein the method comprises the step of rotating the follower about the rotation axis independently of the outer ring to the first retaining position on the outer ring.

The method relates to the practical implementation of the applicator roll and—as such—provides the same or similar technical advantages as the applicator roll and its embodiments, which will not be repeated hereafter.

In one embodiment the method further comprises the step of rotating the follower about the rotation axis independently of the outer ring in a first rotation direction and a second rotation direction opposite to the first rotation direction.

In another embodiment the method further comprises the step of rotating the follower together with the outer ring about the rotation axis while remaining in the first retaining position on the outer ring.

In another embodiment the follower has an angular start position and an angular end position that is offset with respect to the angular start position about the rotation axis, wherein the method further comprises the step of rotating the follower together with the outer ring from the angular start position to the angular end position.

Preferably, the method further comprises the step of returning the follower to the angular start position independently of the outer ring after rotating together with the outer ring from the angular start position to the angular end position.

In another embodiment the method further comprises the steps of rotating the outer ring about the rotation axis independently of the follower over one or more revolutions and rotating the follower about the rotation axis to a second retaining position on the outer ring that is offset with respect to the first retaining position on the outer ring over at least one revolution of the outer ring about the rotation axis with respect to the follower.

In another embodiment the strip has a leading end that is fed onto the retaining surface at the first retaining position, wherein the method further comprises the step of following the leading end at the first retaining position with the follower to retain said leading end to the retaining surface at said first retaining position.

Preferably, the strip has a trailing end that is fed onto the retaining surface at the second retaining position, wherein the method further comprises the step of following the trailing end at the second retaining position with the follower to retain said trailing end to the retaining surface at said second retaining position.

According to a fifth unclaimed aspect, the invention provides an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the applicator roll further comprises a chamber that extends in the circumferential direction over a retaining arc with an arc length along the inside of the outer ring and that is connectable to a vacuum source, wherein the chamber is arranged in air communication with one or more suction openings of the plurality of suction openings within said retaining arc, wherein the arc length is less than one-hundred-and-eighty degrees, preferably less than ninety degrees and more preferably less than forty-five degrees.

The applicator roll according to the fifth aspect of the invention has the advantage that the length of the chamber along the circumference of the outer ring can be limited to an area that is actually covered by the strip during the application process. This is particularly useful in a continuous application process in which the strip is supported only along a very small portion of the circumference of the outer ring. Hence, by preventing air communication between the chamber and suction openings that are not covered by the strip during the process, pressure loss or loss of vacuum through said uncovered suction openings can be prevented. The chamber may for example only extend from the position where the strip is supplied onto the applicator roll from the die, i.e. as close as possible to the extruder die, up to the position where the strip is transferred to the drum, i.e. at the so-called ‘tack position’. These points are typically only ninety degrees offset about the rotation axis of the applicator roll.

According to a sixth unclaimed aspect, the invention provides an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the diameter of the applicator roll is less than thirty centimeters, preferably less than twenty centimeters and most preferably less than fifteen centimeters.

Because of the small dimensions, the applicator roll according to the sixth aspect of the invention can be fit ted in a tire component servicer directly downstream of the extruder die in the extruder direction. The applicator roll can thus be used to pick-up and retain the strip as soon as it leaves the extruder. The applicator roll retains the strip only along a part of its circumference and then applies said strip directly onto the drum. The circumference of the applicator roll according to the sixth aspect of the invention is insufficient to support the entire length of the strip. Hence, the applicator roll cannot be used as a transfer drum or transfer wheel.

The applicator rolls according to the fifth aspect and the sixth aspect of the invention can be combined with any one of the embodiments of the previously described first, second, third and fourth aspect of the invention.

According to a seventh aspect the invention provides a tire component servicer comprising an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the applicator roll further comprises a follower that is rotatable inside the outer ring about the rotation axis to follow a part of the strip on the retaining surface, wherein the follower defines a chamber that extends in the circumferential direction over a retaining arc along the outer ring and that is connectable to a vacuum source, wherein the follower is rotatable about the rotation axis independently of the outer ring to a first retaining position on the outer ring in which the chamber is arranged in air communication with one or more suction openings of the plurality of suction openings within said retaining arc, wherein the tire component servicer comprises a first control element that is coupled to the outer ring for driving the rotation of said outer ring, wherein the follower comprises a first fixation element for fixating the follower in the first retaining position on the outer ring, wherein the tire component servicer comprises a second control element for controlling the first fixation element, wherein the tire component servicer further comprises a control unit that is operationally connected to the first control element and the second control element, wherein the control unit is configured to control the first control element and the second control element such that the follower is rotated together with the outer ring about the rotation axis while remaining in the first retaining position on the outer ring, wherein the tire component servicer further comprises a sensor for detecting the presence of the strip on the applicator roll wherein the control unit is operationally connected to the sensor and configured for controlling the first control element and/or the second control element in response to signals received from the sensor.

The sensor can ensure that the process is initiated only when the presence of the strip, i.e. the leading end, is detected in the first retaining position on the outer ring.

According to an eighth aspect the invention provides a tire component servicer comprising an applicator roll for applying a strip to a drum, wherein the applicator roll comprises an outer ring that is rotatable about a rotation axis and that defines a retaining surface extending in a circumferential direction about the rotation axis, wherein the applicator roll is provided with a plurality of suction openings distributed in the circumferential direction over the retaining surface for retaining the strip to the retaining surface through suction, wherein the applicator roll further comprises a follower that is rotatable inside the outer ring about the rotation axis to follow a part of the strip on the retaining surface, wherein the follower defines a chamber that extends in the circumferential direction over a retaining arc along the outer ring and that is connectable to a vacuum source, wherein the follower is rotatable about the rotation axis independently of the outer ring to a first retaining position on the outer ring in which the chamber is arranged in air communication with one or more suction openings of the plurality of suction openings within said retaining arc, wherein the tire component servicer further comprises an extruder with an extruder die for extruding the strip in an extrusion direction, wherein the applicator roll is located directly downstream of the extruder die in the extruder direction.

The applicator roll can thus be used to pick-up and retain the strip as soon as it leaves the extruder.

The tire component servicer according to the seventh aspect and the eighth aspect of the invention can be combined with any one of the embodiments of the previously described first, second, third, fourth, fifth and sixth aspect of the invention.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows an isometric view of an applicator roll according to a first embodiment of the invention;

FIGS. 2A-2H show side view in cross section of a tire component servicer comprising the applicator roll according to FIG. 1, during the steps of a method of applying a strip to a drum;

FIG. 3 shows a side view in cross section of the tire component servicer according to FIG. 2A with the applicator roll in an alternative starting configuration;

FIG. 4 shows a side view in cross section of an alternative applicator roll according to a second embodiment of the invention;

FIG. 5 shows a side view in cross section of a further alternative applicator roll according to a third embodiment of the invention;

FIG. 6 shows a front view in cross section of the tire component servicer according to FIG. 2A;

FIG. 7 shows a front view in cross section of an alternative tire component servicer with a further alternative applicator roll according to a fourth embodiment of the invention;

FIG. 8 shows a front view in cross section of a further alternative applicator roll according to a fifth embodiment of the invention;

FIG. 9 shows a front view in cross section of a further alternative applicator roll according to a sixth embodiment of the invention; and

FIG. 10 shows a side view in cross section of a further alternative applicator roll according to a seventh embodiment of the invention.

### DETAILED DESCRIPTION OF THE INVENTION

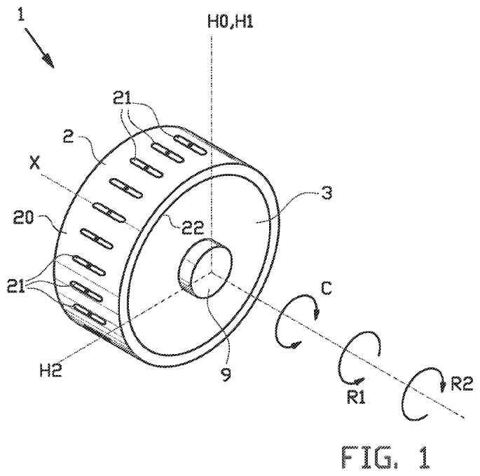

FIGS. 1-3 show an applicator roll or applicator roll 1 for applying a strip S to a drum, in particular a tire building drum D, according to a first exemplary embodiment of the invention.

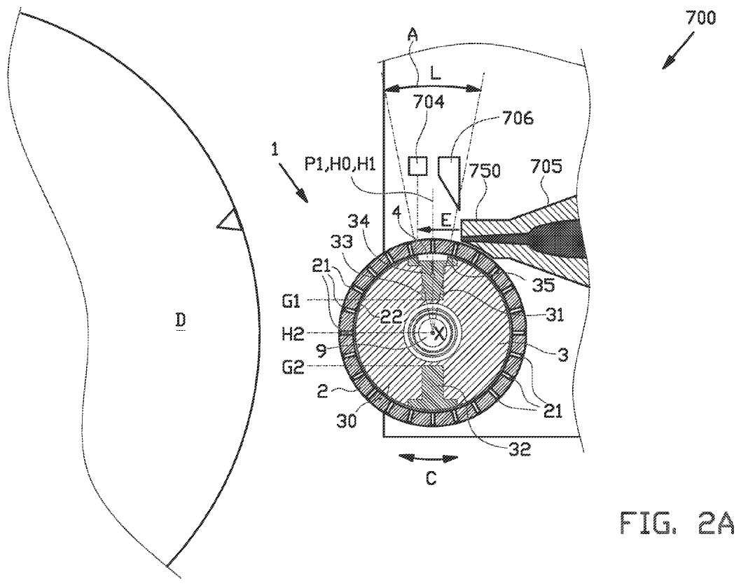

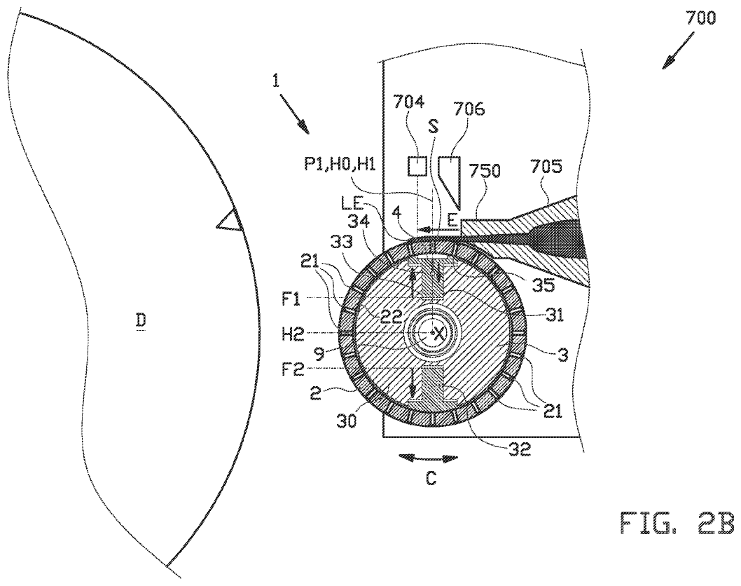

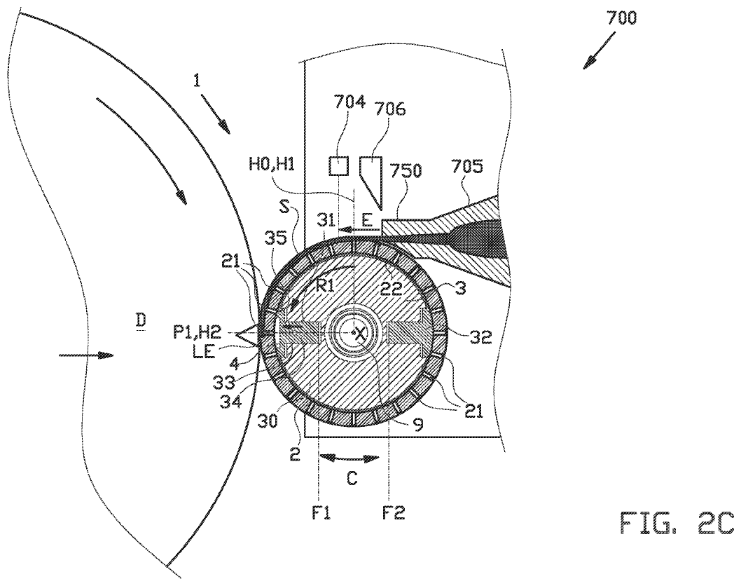

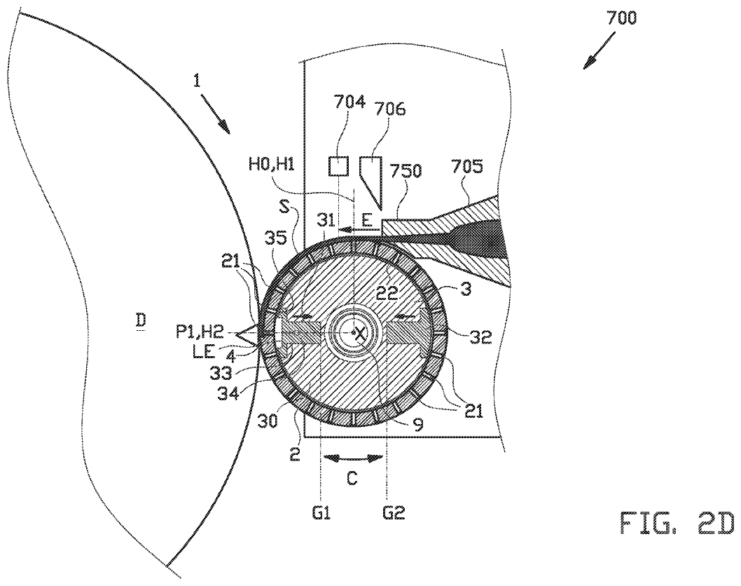

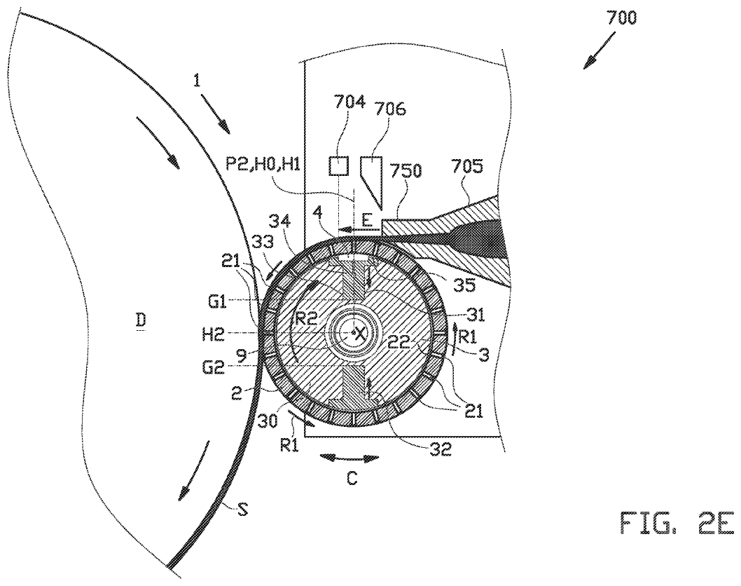

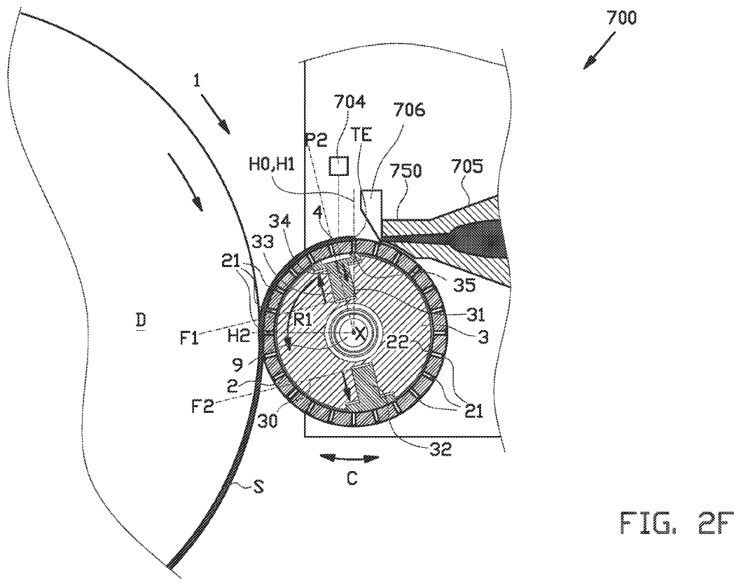

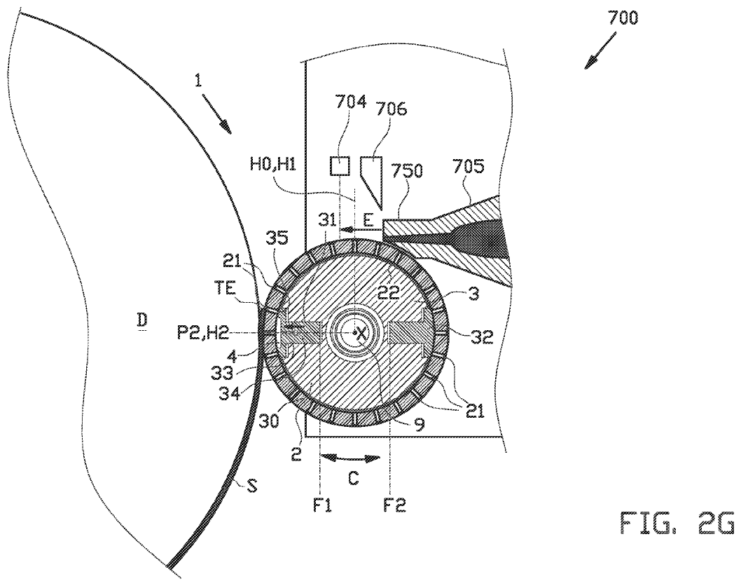

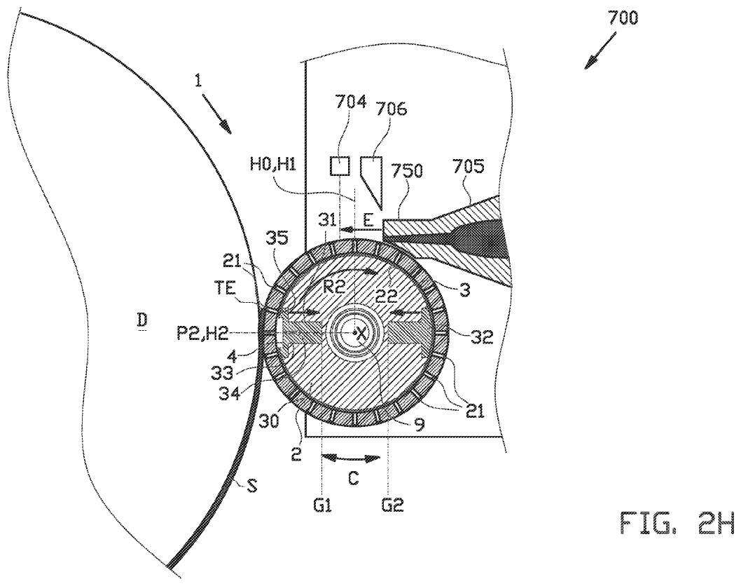

FIGS. 2A-H and 3 show the applicator roll 1 as a part of a tire building station, in particular a tire component servicer 700. The tire component servicer 700 comprises an extruder 705 with an extruder die 750 for extruding the strip S in an extrusion direction E. The applicator roll 1 is located directly downstream of the extruder die 750 in the extruder direction E.

The tire component servicer 700 further comprises a sensor 704 for detecting the presence of the strip S on the applicator roll 1 and a knife 406 for cutting the strip S to length at or near the extruder die 750.

FIGS. 2A-2H show the steps of a method for creating a strip S and applying said strip S to the drum D. As shown in FIG. 2B, the strip S has a leading end LE that is created by cutting-off a previous length of the strip S during a previous cycle of the method. The applicator roll 1 is then rotated to apply a length of the strip S to the drum D. Once the extruder 405 has extruded a preset length of the strip S, the knife 406 is activated to cut the strip S to length, as shown in FIG. 2F, thereby creating a trailing end TE. The strip S is preferably made from an elastomeric material, i.e. rubber, and can be applied as a finished tire component to the drum D or as a raw material for forming a tire component on the drum D during a strip-winding method in a manner known per se.

The present invention is related to the configuration of the applicator roll 1, which will be discussed hereafter in more detail.

As shown in FIG. 1, the applicator roll 1 comprises an outer ring 2 that is rotatable about a rotation axis X. The applicator roll 1 may be rotatably supported on a shaft 9 at the rotation axis X. The outer ring 2 defines a retaining surface 20 extending in a circumferential direction C about the rotation axis X. During application, the outer ring 3 is driven in a first rotation direction R1, thereby feeding the strip S towards the drum D. In this exemplary embodiment, the retaining surface 20 is cylindrical or substantially cylindrical, preferably straight-cylindrical. The applicator roll 1 is provided with a plurality of suction openings 21 distributed in the circumferential direction C over the retaining surface 20 for retaining the strip S to the retaining surface 20 through suction. Preferably, the suction openings 21 are evenly distributed along the circumference of the retaining surface 20. In the exemplary embodiment as shown, the suction openings 21 debouch into suction cups with an elongated shape. Alternatively, suction cups with different geometry may be used, i.e. circular or even non-circular. Each suction opening 21 is located in the center or middle of its respective suction cup.

The diameter of the applicator roll 1 at the outer ring 2 is less than thirty centimeters, preferably less than twenty centimeters and most preferably less than fifteen centimeters. Hence, the applicator roll 1 can be fitted directly downstream of the extruder die 750 in the extruder direction E, as shown in FIG. 2A.

As shown in FIGS. 2A-2H, the applicator roll 1 further comprises a follower 3 that is rotatable inside or within the outer ring 2 about the rotation axis X. The follower 3 comprises a follower body 30 which, in this exemplary embodiment, has the shape of an inner ring or an inner disc. Said inner disc fits concentrically inside the outer ring 2 and supports said outer ring 2 with respect to the rotation axis X during the rotation thereof. It is noted that the follower body 30 does not need to have a disc shape. Alternatively, the follower body 30 may comprise only a section or segment of a disc or a different shape, i.e. spokes, providing support to the outer ring 2 and/or components of the follower 3 only where needed.

As best seen in FIG. 2A, the follower 3 defines a chamber 4 that extends in the circumferential direction C over a retaining arc A with an arc length L along the outer ring 2. The arc length L is relatively small compared to the overall circumference of the applicator roll 1. In this particular embodiment, the arc length L is less than thirty degrees. The chamber 4 is connectable to a pump unit 900, as schematically shown in FIG. 6. The pump unit 900 may act as a source of (partial) vacuum, as schematically shown with (−), or a source of compressed air, as schematically shown with (+). The pump unit 900 can be reversed to switch between the (partial) vacuum and the compressed air. The pump unit 900 may also comprise two pumps, one for the (partial) vacuum and one for the compressed air, and a valve that can switch between the two pumps. Hence, air may be selectively drawn from or provided to the chamber 4 to retain the strip S through suction or to blow off said strip with an overpressure, respectively.

The follower 3 is rotatable independently of the outer ring 2 in the first rotation direction R1 and/or the second rotation direction R2 opposite to the first rotation direction R1. More in particular, the follower 3 is arranged to be rotatable at least in a range from an angular start position H1, as shown in FIGS. 2A and 2E, to an angular end position H2, as shown in FIGS. 2C and 2G. In this exemplary embodiment, the angular start position H1 corresponds to a zero position HO, which is the position in which the chamber 4 points vertically upwards. The angular end position H2 is offset with respect to the angular start position H1 about, with respect to or relative to the rotation axis X, in this exemplary embodiment by about ninety degrees.

The follower 3 is arranged or configured to follow a part of the strip S on the retaining surface 20, in particular the leading end LE in FIGS. 2B-2D and the trailing end TE in FIGS. 2F-2H. During the following of the strip S, the follower 3 is configured or arranged to rotate at the same speed, substantially the same speed or together with the outer ring 2 from the angular start position H1, as shown in FIGS. 2A and 2E, to the angular end position H2, as shown in FIGS. 2C and 2G. When the follower 3 is not following the leading end LE or the trailing end TE, it can be rotated independently of the outer ring 2, i.e. to return from its angular end position H2, as shown in FIGS. 2C and 2G, to its angular start position H1, as shown in FIGS. 2A or 2E. The return rotation may be in the first rotation direction R1 or in the second rotation direction R2.

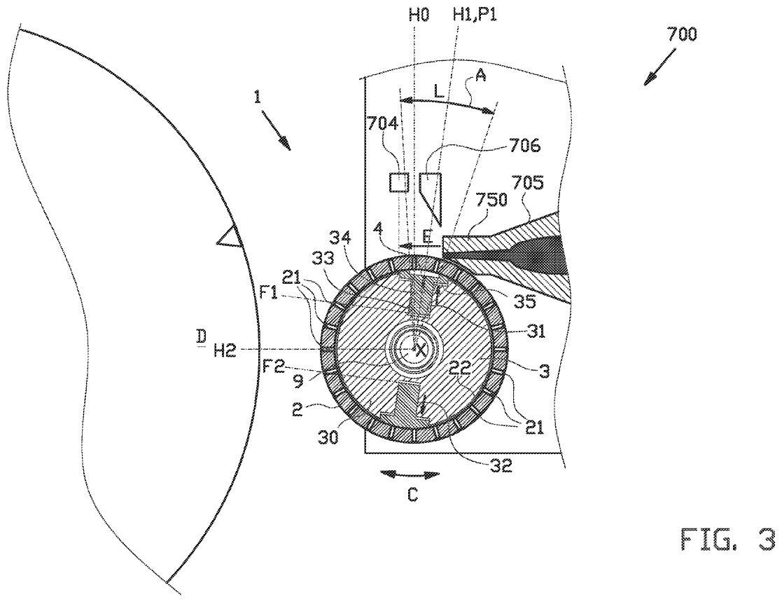

The follower 3 is rotatable about the rotation axis X independently of the outer ring 2 to a first retaining position P1 on or along the outer ring 2 in which the chamber 4 is arranged in air communication with one or more suction openings 21 of the plurality of suction openings 21 within said retaining arc A. In the embodiment as shown in FIG. 2A, the chamber 4 connects to one of the suction openings 21 only in the first retaining position P1. The first retaining position P1 corresponds to the position where the leading end LE is first applied to or supported by the applicator roll 1 directly downstream of the extruder die 450, as shown in FIG. 2B. In FIG. 2B, the first retaining position P1 is aligned with the angular start position H1 and the zero position HO. Alternatively, as shown in FIG. 3, the first retaining position P1 may be tilted slightly backwards with respect to the angular zero position HO to communicate with two or more of the suction openings 21 at a time. The arc length L of the chamber 4 may also be increased to communicate with more suction openings 21 along said arc length L.

When comparing FIGS. 2A, 2B and 2C, it can be observed that the follower 3 remains in the first position P1 with respect to the outer ring 2. This is obtained by rotating the follower 3 at the same speed or rotational velocity and in the same first rotation direction R1 as the outer ring 2. In this first exemplary embodiment of the invention, the follower 3 is arranged to be temporarily or selectively fixated relative to the outer ring 2 so that the follower 3 and the outer ring 2 may rotate as one or in unison.

In particular, the follower 3 comprises a first fixation element 31 and a second fixation element 32 for fixating the follower 3 in the first retaining position P1 at, along or on the outer ring 2. In this exemplary embodiment, the second fixation element 32 is located diametrically opposite to the first fixation element 31. The first fixation element 31 is movable between a first fixation position F1 in abutment with the outer ring 2, as shown in FIGS. 2B, 2C, 2F and 2G, and a first retracted position G1 spaced apart from the outer ring 2, as shown in FIGS. 2A, 2D, 2E and 2H Similarly, the second fixation element 32 is movable in a direction opposite to the first fixation element 31 between a second fixation position F2 in abutment with the outer ring 2 and a first retracted position G2 spaced apart from the outer ring 2.

In this exemplary embodiment, the chamber 4 of the follower 3 is formed in the first fixation element 31. More in particular, the first fixation element 31 seals the chamber 4 from communication with any one of the suction openings 21 of the plurality of suction openings 21 outside of the retaining arc A. Meanwhile, in the first retracted position F1 of the first fixation element 31, as shown in FIG. 2A, the chamber 4 is in open communication with the suction openings 21 of the plurality of suction openings 21 outside of the retaining arc A.

The second fixation element 32 differs from the first fixation element 31 only in that it does not have the chamber 4. Hence, the structure and functionality of the fixation elements 31, 32 will be discussed hereafter with reference to the first fixation element 31 only.

As best seen when comparing FIGS. 2A and 2B, the first fixation element 31 comprises a cylinder 33 and a piston 34 that is movable in said cylinder 33 between the first fixation position F1 and the first retracted position G1. The piston 34 may be pneumatically or hydraulically driven. In the pneumatic option, the pressure may be provided by a valve block of the same pump unit 900 that also provides the suction or compressed air to the chamber 4, as schematically shown in FIG. 6. Alternatively, a separate drive source may be provided (not shown).

As shown in FIG. 2B, the piston 34 comprises a braking surface 35 for contacting the outer ring 2 in the first fixation position F1. Specifically, the braking surface 35 is arranged for contacting the inwardly facing surface or inside of the outer ring 2. The braking surface 35 is arranged to generate friction between the first fixation element 31 and the outer ring 2 in the circumferential direction C to fixate or retain the follower 3 to the outer ring 2. Hence, the follower 3, once fixated, can ‘tag along’ or ‘piggyback’ with the rotation of the outer ring 2. Hence, the follower 3 itself does not require an active rotational drive to control its rotational position. The friction between the braking surface 35 and the outer ring 2 may optionally be improved by providing the braking surface 35 with a suitable high-friction braking material or a texture.

It will be appreciated by one skilled in the art that one fixation element 31 may be sufficient to fixate the follower 3 with respect to the outer ring 2. Alternatively, more than two fixation elements 31 may be used. Also, different types of fixation elements 31, 32 can be envisioned, i.e. magnetic fixation elements, suction fixation elements, mechanically interlocking fixation elements, etc.

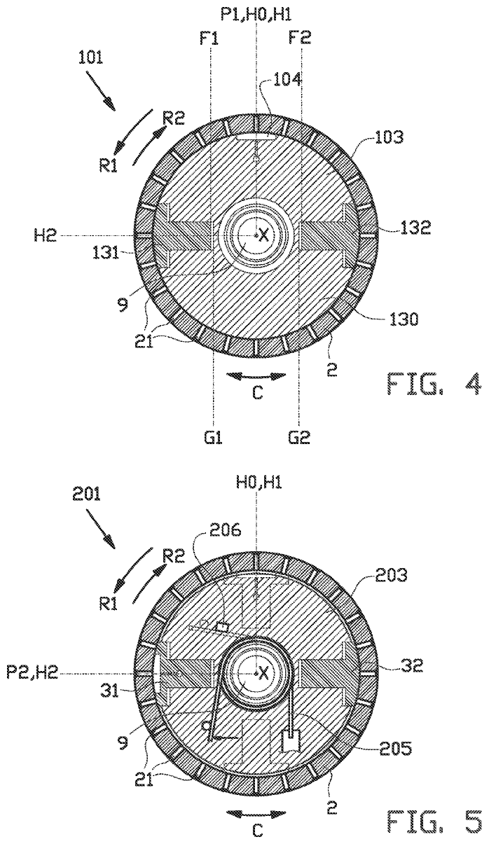

Moreover, FIG. 4 shows an alternative applicator roll 101 according to a second exemplary embodiment of the invention which differs from the aforementioned applicator roll 1 only in that its chamber 104 is formed in the follower body 130 of the follower 103 rather than the fixation elements 131, 132. Hence, the fixation elements 131, 132 have the sole purpose of fixating and releasing the follower 103 relative the outer ring 2. Suitable sealing members (not shown) may be provided between the follower body 130 and the outer ring 2 to seal the chamber 104.

Once the fixation elements 31, 32 are retracted into their respective retracted positions G1, G2, as for example shown in FIGS. 2D and 2H, the follower 3 is freely and/or independently rotatable with respect to the outer ring 2, i.e. to return to the angular start position H1 as shown in FIGS. 2A and 2E, respectively.

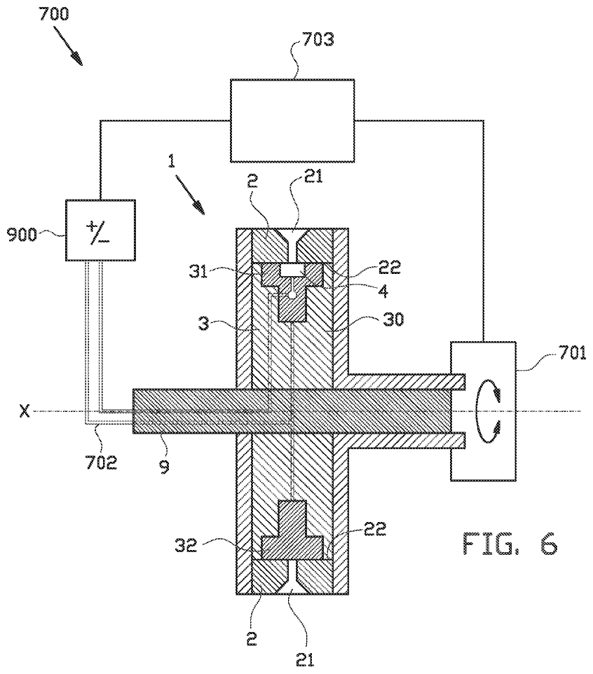

FIG. 5 shows an alternative applicator roll 201 according to a third exemplary embodiment of the invention which differs from the aforementioned applicator roll 1 in that it is provided with a biasing member 205 that, in the absence of any active rotational drive for the follower 203, can bias or urge the follower 203 to rotate in the second rotation direction R2 to return to the angular start position H1. Preferably, the alternative applicator roll 201 further comprises a stopper element 206 for preventing rotation of the follower 203 in the second rotation direction R2 beyond the angular start position H1.

As schematically shown in FIG. 6 the tire component servicer 700 comprises a first control element 701 that is coupled to the outer ring 2 for driving the rotation of said outer ring 2 and a second control element 702 for controlling the fixation elements 31, 32. The tire component servicer 700 further comprises a control unit 703 that is operationally connected to the first control element 701 and the second control element 702. The first control element 701 may for example be a rotational drive for actively driving the rotation of the outer ring 2. The second control element 702 may be a valve block or conduit between the pump unit 900 and the fixation elements 31, 32. The control unit 703 is adapted, programmed, configured, arranged and/or comprises software or instructions to control the first control element 401 and the second control element 702. In particular, the control unit 703 is arranged for controlling the first control element 701 to rotate the outer ring 2 and for controlling the second control element 702 to fixate the follower 3 to the outer ring 2 in the angular start position H1 and to release the follower 3 from the outer ring 2 in the angular end position H2. Hence, the follower 3 can be rotated together with the outer ring 2 about the rotation axis X between the angular start position H1 and the angular end position H2 while remaining in the first retaining position P1 on the outer ring 2.

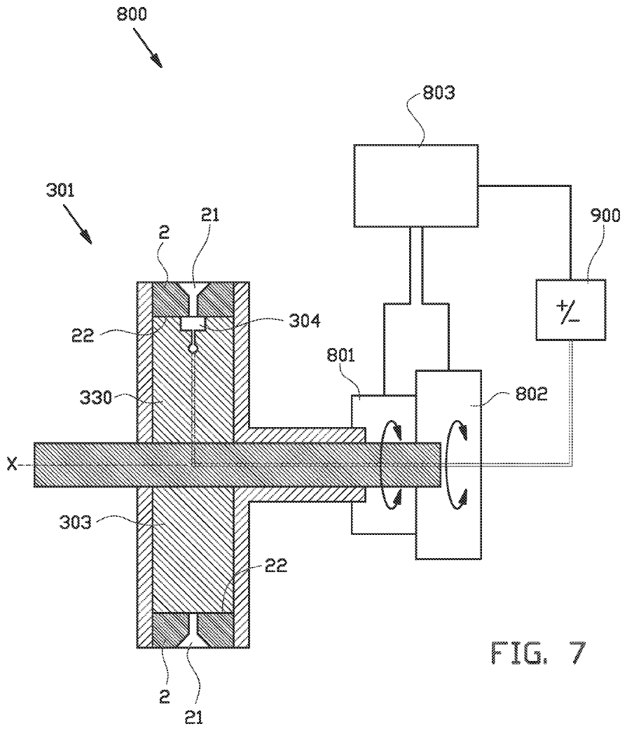

FIG. 7 shows an alternative tire component servicer 800 according to a fourth embodiment of the invention that differs from the previously discussed tire component servicer 700 only in that the tire component servicer 800 comprises a second control element 802 that is coupled to the follower 303 for driving the rotation of the follower 303. The second control element 802 may for example be a second rotation drive, in addition to the first rotational drive that controls and/or drives the rotation of the outer ring 2, for actively controlling and/or driving the rotation of the follower 303. Hence, the angular position of the follower 303 can be controlled directly and independently of the outer ring 2 and the follower 303 does not require fixation elements. The chamber 304 can be formed directly in the follower body 330. The control unit 803 is operationally connected to the first control element 801 and the second control element 802 to control and/or synchronize the rotations of the outer ring 2 and the follower 303 independently. In this alternative embodiment, the control unit 803 is adapted, programmed, configured, arranged and/or comprises software or instructions to control the control elements 801, 802 to rotate and/or synchronize the outer ring 2 and the follower 303 at the same speed or substantially the same speed at least from the angular start position H1 to the angular end position H2.

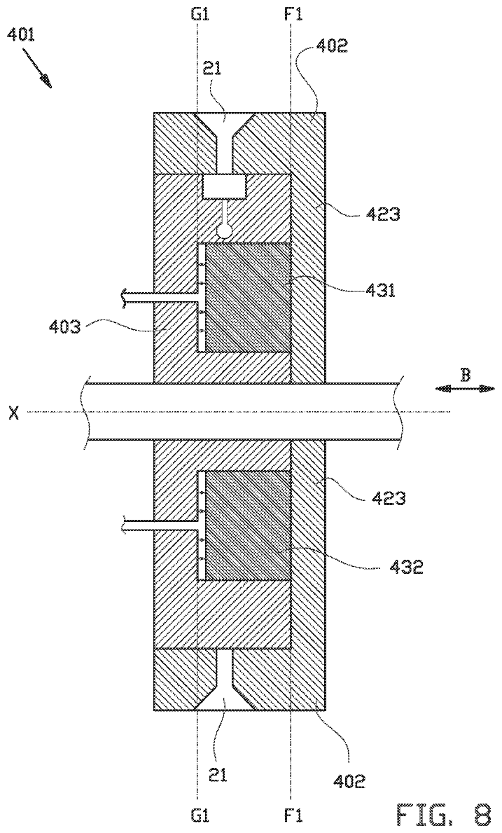

FIG. 8 shows a further alternative tire applicator roll 401 according to a fifth embodiment of the invention that differs from the previously discussed applicator rolls 1, 101, 201, 301 in that the further alternative applicator roll 401 comprises a side wall 423 connected to the outer ring 402. The fixation elements 431, 432 fixate the follower 403 in the first retaining position or the second retaining position on the outer ring 402 via the side wall 423 or through acting on the side wall 423, i.e. via contact or direct abutment with said side wall 423 in an axial direction B parallel to the rotation axis X. In particular, the fixation elements 431, 432 may be similar in configuration as the fixation elements 31, 32, i.e. with a cylinder and a piston movable in said cylinder. The piston has a braking surface that is arranged to contact the side wall 423 and generate enough friction between the side wall 423 and the respective fixation element 31, 32 to hold the follower 403 in a fixed angular position with respect to the outer ring 402.

Alternatively, the fixation elements may comprise one or more mechanically interlocking elements, i.e. cams, pins and/or slots, to hold the angular position through mechanical interlock.

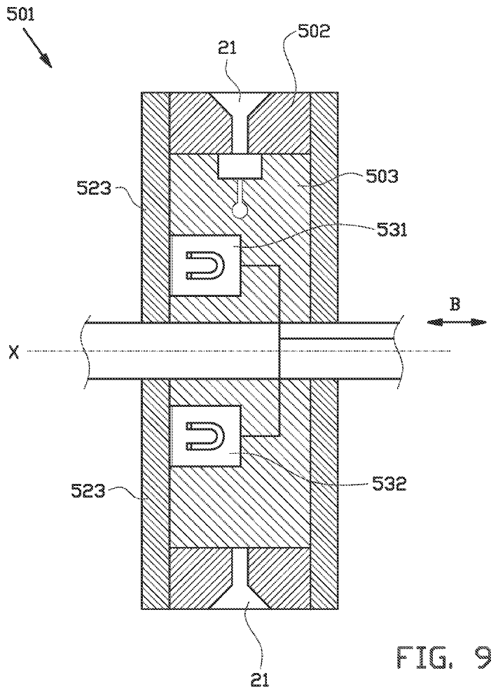

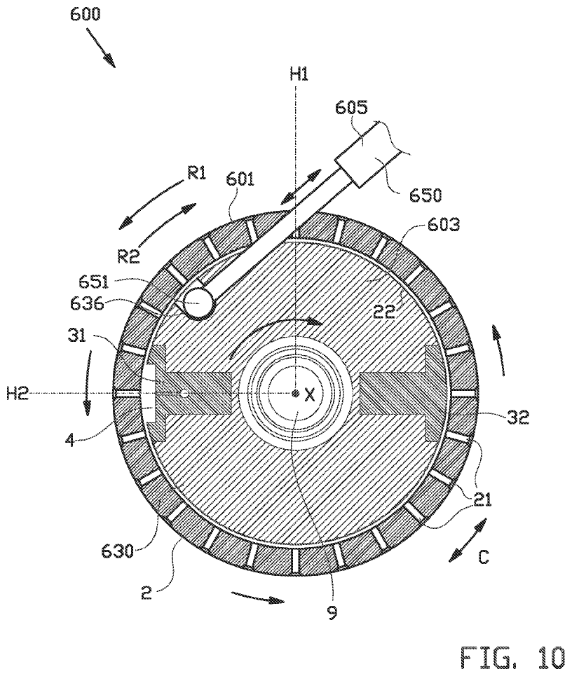

FIG. 9 shows a further alternative tire applicator roll 501 according to a sixth embodiment of the invention that differs from the previously discussed applicator rolls 1, 101, 201, 301, 401 in that the outer ring 502 is provided with a side wall 523 and in that the fixation elements 531, 532 fixate the follower 503 in the first retaining position or the second retaining position on the outer ring 502 via the side wall 523 or by acting on the side wall 523. In particular, the fixation elements 531, 532 exert a magnetic force onto said side wall 523. More in particular, the fixation elements 531, 532 may be electromagnets that can be switched on and off to control the fixation of the follower 503 relative to the side wall 523, and thus the outer ring 502 as a whole.

FIG. 10 shows a further alternative tire component servicer 600 according to a seventh embodiment of the invention that differs from the previously discussed tire component servicers 700, 800 in that its biasing member is not part of the applicator roll 601. Instead, the biasing member is formed by an actively controllable actuator 605, in this case in the form of a pneumatic or hydraulic cylinder 650 and a piston 651 that is movable relative to said cylinder 650. The follower 603 has a follower body 630 that is provided with a recess or slot 636 for receiving the piston 651. Hence, the piston 651 can engage directly onto a portion of the follower body 630. By controlling the extension and/or retraction of the piston 651, the angular position of the follower body 630 can be controlled. In this exemplary embodiment, the actuator 605 is arranged for passively following the rotation of the follower 603 when inactive or unpowered, i.e. during the rotation of the follower 603 from the angular start position H1 to the angular end position H2, and for actively returning the follower 603 to the angular start position H1 when active or powered.

A method for applying the strip S to the drum D with the use of any one of the previously applicator rolls 1, 101, 201, 301, 401, 501, 601 will be elucidated hereafter with reference to FIGS. 1-10.

FIGS. 2A and 3 show the situation prior to extrusion of the leading end LE of the strip S. The follower 3 inside the applicator roll 1 has been returned to or positioned in the angular start position H1. The outer ring 2 is held stationary. The fixation elements 31, 32 are retracted into their respective retracted positions G1, G2.

FIG. 2B shows the situation in which the extruder 405 has extruded the leading end LE of the strip S onto the applicator roll 1. The outer ring 2 remains stationary or may rotate slightly to take on the leading end LE, depending on the configuration. Once the leading end LE covers the one or more suction openings 21 that communicates with the chamber 4, the fixation elements 31, 32 are moved into their respective fixation positions F1, F2. The fixation elements 31, 32 may be controlled in response to signals from the sensor 404, detecting the presence or arrival of the leading end LE. Alternatively, the fixation elements 31, 32 may already have moved into their respective fixation positions F1, F2 prior to the extrusion of the leading end LE so that the leading end LE is retained as soon as it covers the respective one or more suction openings 21.

At any point during the aforementioned steps, the pump unit 900 (show in FIG. 6) may be activated to draw air from the chamber 4, thereby retaining the leading end LE to the applicator roll 1 through suction. The position where the leading end LE is retained to the outer ring 2 is the first retaining position P1.

FIG. 2C shows the situation after the outer ring 2 has been rotated, with the leading end LE retained thereto in the first retaining position P1, from the angular start position H1 into the angular end position H2. The drum D has been moved into the contact with the leading end LE opposite to the applicator roll 1 and is now ready to take on the leading end LE. The position where the leading end LE is received on the drum D is also known as the ‘tack position’. The drum D may be provided with retaining means, i.e. suction openings (not shown), for taking over the leading end LE from the applicator roll in the tack position. Note that the follower 3 has remained fixated to the outer ring 2 during the rotation of the outer ring 2 and, consequently, has been rotated together with or in unison with the outer ring 2 into the angular end position H2, while remaining in the first retaining position P1 on the outer ring 2. The pump unit 900 of FIG. 6 may now be reversed to supply compressed air to the chamber 4 in order to facilitate the release or blow-off of the leading end LE from the applicator roll 1.

FIG. 2D shows the situation in which the fixation elements 31, 32 are again retracted to their respective retracted positions G1, G2 to release or terminate the fixation of the follower 3 with respect to the outer ring 2.

FIG. 2E shows the situation in which the follower 3 has been returned to the angular start position H1 in the second rotation direction R2 while the outer ring 2 is rotated further in the first rotation direction R1 over one or several revolutions, depending on the length of the strip S.

The steps as shown in FIGS. 2A-2E are now repeated for the trailing end TE on a second retaining position P2 of the outer ring 2 corresponding to the position where said trailing end TE is first applied to or supported on the outer ring 2. FIGS. 2F-2H only show some key moments of the retaining and release of the trailing end TE, but it will be understood that the steps of FIGS. 2A-2E apply here as well.

FIG. 2F shows the situation in which the knife 406 has cut the strip S to length and has created the trailing end TE. The fixation elements 31, 32 have again been moved into their respective fixation positions F1, F2 to fixate the follower 3 to the outer ring 2 in a second retaining position P2 that corresponds to the position where the trailing end TE is located on the outer ring 2. This second retaining position P2 may be offset with respect to the first retaining position P1 over one or several revolutions of the outer ring 2 about the rotation axis X with respect to the follower 3, depending on the length of the strip S between the leading end LE and the trailing end TE. Note that the first retaining position P1 and the second retaining position P2 may (partially) overlap when offset over one or more full revolutions of the outer ring 2.

The situation as shown in FIG. 2G corresponds to the step as shown in FIG. 2C. The situation as shown in FIG. 2H corresponds to the situation as shown in FIG. 2D. The follower 3 may now be returned again to the angular start position H1 as shown in FIG. 2A to repeat the entire cycle.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

In summary, the invention relates to an applicator roll 1, 101, 201, 301, 401, 501, 601 a tire component servicer 600, 700, 800 and a method for applying a strip S to a drum D. The applicator roll 1, 101, 201, 301, 401, 501, 601 comprises an outer ring 2 that is rotatable about a rotation axis X and that defines a retaining surface 20, wherein the applicator roll 1, 101, 201, 301, 401, 501, 601 is provided with suction openings 21 for retaining the strip S to the retaining surface 20, wherein the applicator roll 1, 101, 201, 301, 401, 501, 601 comprises a follower 3, 103, 203, 303, 603 that is rotatable inside the outer ring 2 to follow a part LE, TE of the strip S on the retaining surface 20, wherein the follower 3, 103, 203, 303, 603 defines a chamber 4, 104 that extends in the circumferential direction C over a retaining arc A with an arc length L along the outer ring 2, wherein the follower 3, 103, 203, 303, 603 is rotatable about the rotation axis X independently of the outer ring 2 to a first retaining position P1 on the outer ring 2 in which the chamber 4, 104 is arranged in air communication with one or more suction openings 21 within said retaining arc A.

1-42. (canceled)

43. An applicator roll for applying a strip to a drum, wherein the applicator roll comprises an outer ring that is rotatable about a rotation axis and that defines a retaining surface extending in a circumferential direction about the rotation axis,
wherein the applicator roll is provided with a plurality of suction openings distributed in the circumferential direction over the retaining surface for retaining the strip to the retaining surface through suction,
wherein the applicator roll further comprises a follower that is rotatable inside the outer ring about the rotation axis to follow a part of the strip on the retaining surface,
wherein the follower defines a chamber that extends in the circumferential direction over a retaining arc along the outer ring and that is connectable to a vacuum source,
wherein the follower is rotatable about the rotation axis independently of the outer ring to a first retaining position on the outer ring in which the chamber is arranged in air communication with one or more suction openings of the plurality of suction openings within said retaining arc,
wherein the follower is arranged for rotation together with the outer ring about the rotation axis while remaining in the first retaining position on the outer ring,
wherein the follower comprises a first fixation element for fixating the follower in the first retaining position on the outer ring.

44. The applicator roll according to claim 43, wherein the follower is rotatable about the rotation axis independently of the outer ring in a first rotation direction and a second rotation direction opposite to the first rotation direction.

45. The applicator roll according to claim 43, wherein the follower is freely rotatable about the rotation axis independently of the outer ring when the first fixation element has terminated the fixation of the follower on the outer ring.

46. The applicator roll according to claim 43, wherein the first fixation element is movable between a first fixation position in abutment with the outer ring and a first retracted position spaced apart from the outer ring, wherein the fixation of the follower to the outer ring is obtained by friction between the first fixation element and the outer ring in the first fixation position.

47. The applicator roll according to claim 46, wherein the follower comprises a second fixation element that is arranged for abutting the outer ring in a second fixation position.

48. The applicator roll according to claim 47, wherein the second fixation position is diametrically opposite to the first fixation position.

49. The applicator roll according to claim 43, wherein the chamber is formed in the first fixation element.

50. The applicator roll according to claim 46, wherein, in the first fixation position, the first fixation element seals the chamber from communication with any one of the suction openings of the plurality of suction openings outside of the retaining arc and wherein, in the first retracted position, the chamber is in open communication with the suction openings of the plurality of suction openings outside of the retaining arc.

51. The applicator roll according to claim 46, wherein the first fixation element comprises a cylinder and a piston movable in said cylinder between the first fixation position and the first retracted position,
wherein the piston comprises a braking surface for contacting the outer ring in the first fixation position.

52. The applicator roll according to claim 43, wherein the applicator roll comprises a side wall connected to the outer ring,
wherein the first fixation element is arranged for fixating the follower in the first retaining position on the outer ring via the side wall.

53. The applicator roll according to claim 52 wherein the first fixation element is movable between a first fixation position in abutment with the side wall and a first retracted position spaced apart from the side wall in an axial direction parallel to the rotation axis,
wherein the fixation of the follower to the outer ring is obtained by friction between the first fixation element and the side wall in the first fixation position.

54. The applicator roll according to claim 43, wherein the follower has an angular start position and an angular end position that is offset with respect to the angular start position about the rotation axis,
wherein the follower is arranged for rotating together with the outer ring from the angular start position to the angular end position.

55. The applicator roll according to claim 54, wherein the angular end position is offset from the angular start position over at least thirty degrees about the rotation axis.

56. The applicator roll according to claim 54, wherein the angular end position is offset from the angular start position over less than one-hundred-and-eighty degrees.

57. The applicator roll according to claim 54, wherein the follower is arranged for returning to the angular start position independently of the outer ring after rotating together with the outer ring from the angular start position to the angular end position.

58. The applicator roll according to claim 57, wherein the follower is arranged for rotating from the angular start position to the angular end position in a first rotation direction,
wherein the applicator roll comprises a biasing member for biasing the follower in a second rotation direction opposite to the first rotation direction to return to the angular start position.

59. The applicator roll according to claim 58, wherein the applicator roll comprises a stopper element for preventing rotation of the follower in the second rotation direction beyond the angular start position.

60. The applicator roll according to claim 54, wherein the follower has a zero position in which the chamber is pointing vertically upwards,
wherein the angular start position is offset with respect to the zero position over three to twenty degrees.

61. The applicator roll according to claim 43, wherein the outer ring is rotatable about the rotation axis independently of the follower over one or more revolutions,
wherein the follower is rotatable about the rotation axis to a second retaining position on the outer ring that is offset with respect to the first retaining position on the outer ring over at least one revolution of the outer ring about the rotation axis with respect to the follower.

62. The applicator roll according to claim 43, wherein the retaining arc has an arc length that is less than one-hundred-and-eighty degrees.

63. The applicator roll according to claim 43, wherein the retaining arc has an arc length that is chosen such that five suction openings of the plurality of suction openings or less are in air communication with the chamber at a time.

64. A tire component servicer comprising the applicator roll according to claim 43.

65. The tire component servicer according to claim 64, wherein the tire component servicer comprises a first control element that is coupled to the outer ring for driving the rotation of said outer ring.

66. The tire component servicer according to claim 65, wherein the follower comprises a first fixation element for fixating the follower in the first retaining position on the outer ring,
wherein the tire component servicer comprises a second control element for controlling the first fixation element.

67. The tire component servicer according to claim 64, wherein the tire component servicer comprises a vacuum source,
wherein the chamber is connectable to said vacuum source.

68. The tire component servicer according to claim 64, wherein tire component servicer further comprises a pump unit that is arranged for selectively providing a partial vacuum or compressed air to the chamber.

69. The tire component servicer according to claim 64, wherein the tire component servicer further comprises an extruder with an extruder die for extruding the strip in an extrusion direction,
wherein the applicator roll is located directly downstream of the extruder die in the extruder direction.

70. The tire component servicer according to claim 69, wherein the rotation axis of the applicator roll is in a fixed position with respect to the extruder die.

71. The tire component servicer according to claim 64, wherein the follower has an angular start position and an angular end position that is offset with respect to the angular start position about the rotation axis,
wherein the follower is arranged for rotating together with the outer ring from the angular start position to the angular end position,
wherein the follower is arranged for returning to the angular start position independently of the outer ring after rotating together with the outer ring from the angular start position to the angular end position,
wherein the tire component servicer comprises a controllable actuator,
wherein the controllable actuator is arranged for engaging directly onto a portion of the follower for actively returning the follower from the angular end position to the angular start position independently of the outer ring after rotating together with the outer ring from the angular start position to the angular end position.

72. A method for applying a strip to a drum using the applicator roll according to claim 43, wherein the method comprises the step of rotating the follower about the rotation axis independently of the outer ring to the first retaining position on the outer ring.

73. The method according to claim 72, wherein the method further comprises the step of rotating the follower about the rotation axis independently of the outer ring in a first rotation direction and a second rotation direction opposite to the first rotation direction.

74. The method according to claim 72, wherein the method further comprises the step of rotating the follower together with the outer ring about the rotation axis while remaining in the first retaining position on the outer ring.

75. The method according to claim 72, wherein the follower has an angular start position and an angular end position that is offset with respect to the angular start position about the rotation axis,
wherein the method further comprises the step of rotating the follower together with the outer ring from the angular start position to the angular end position.

76. The method according to claim 75, wherein the method further comprises the step of returning the follower to the angular start position independently of the outer ring after rotating together with the outer ring from the angular start position to the angular end position.

77. The method according to claim 72, wherein the method further comprises the steps of rotating the outer ring about the rotation axis independently of the follower over one or more revolutions and rotating the follower about the rotation axis to a second retaining position on the outer ring that is offset with respect to the first retaining position on the outer ring over at least one revolution of the outer ring about the rotation axis with respect to the follower.

78. The method according to claim 72, wherein the strip has a leading end that is fed onto the retaining surface at the first retaining position,
wherein the method further comprises the step of following the leading end at the first retaining position with the follower to retain said leading end to the retaining surface at said first retaining position.

79. The method according to claim 77, wherein the strip has a trailing end that is fed onto the retaining surface at the second retaining position,
wherein the method further comprises the step of following the trailing end at the second retaining position with the follower to retain said trailing end to the retaining surface at said second retaining position.
